(19) United States
(12) Patent Application Publication
(10) Pub. No.: US 2007/0297407 A1
(43) Pub. Date: Dec. 27, 2007

(54) Communication Apparatus and Communication System

(75) Inventor: Hitoshi Kubota, Tokyo (JP)

Correspondence Address: BUCHANAN, INGERSOLL & ROONEY PC, POST OFFICE BOX 1404, ALEXANDRIA, VA, 22313-1404, US

(73) Assignee: Renesas Technology Corp., Tokyo (JP)

(21) Appl. No.: 11/766,638

(22) Filed: Jun. 21, 2007

(30) Foreign Application Priority Data
Jun. 23, 2006 (JP) 2006-174397

(51) Int. Cl. H04L 12/56

(52) U.S. Cl. 370/390

(57) ABSTRACT

A communication apparatus that constitutes a communication system including a group of communication apparatuses identified by a first identifier, and includes a storage unit, a control unit, and a broadcasting unit. The storage unit is configured to store a first identifier of a group to which the communication apparatus belongs. The control unit controls exchange of signals for setting a first identifier. The broadcasting unit broadcasts a first-identifier request signal to other communication apparatuses. Upon receipt of a first-identifier notification signal that includes a first identifier in response to the first-identifier request signal, the control unit stores the first identifier in the storage unit for use in communication.

### BACKGROUND OF THE INVENTION

1. Field of the Invention

The present invention relates to a technology for assigning a subnet address to a communication apparatus.

2. Description of the Related Art

A technology has been proposed in which household electrical appliances such as a lighting device and an air conditioner are connected to a network, and remotely monitored or automatically controlled to reduce energy consumption and improve convenience.

As a communication medium used in the network for the above purposes, for example, power line communication and radio communication, which do not require a new data line to be constructed for connecting between appliances have remarkable prospects.

In use of any type of communication medium, an identifier (a node address) for identifying an individual appliance is required at the time of communication. When a communication medium that cannot physically cut off transmission of signals by separating a transmission medium such as the power line communication or radio communication is used, for example, means for setting an identifier (a subnet address) for identifying a group, which is in a unit of dwelling or household, needs to be set to perform filtering of signals logically.

Besides, a technology is necessary for easily setting an address to be used for communication, such as the node address and the subnet address, so that the household electrical appliances are connected via the network, and anyone can easily gain advantages such as reduction of energy consumption and improvement of usability, by performing automatic control, a remote operation, and monitoring the operation relative to these appliances.

To easily set the address to be used for communication, for example, Japanese Patent Application Laid-open Nos. 2003-209551 and 2004-48175 describe a method in which a communication apparatus, whose node address has not been set, autonomously sets a temporary node address, transmits a signal for confirming whether there is an apparatus using the same node address in the same subnet, and when a signal for notifying that the same address is being used is not received from another communication apparatus within a certain time period, uses the temporary address as a normal address.

Japanese Patent Application Laid-open No. 2003-46519 describes a method in which an apparatus (a setting apparatus) that sets an address to a communication apparatus, whose address has not been set (an apparatus to be set), searches an available node address in a subnetwork, to which the apparatus belongs, to easily assign an address to the apparatus to be set, and broadcasts a search result to the subnetwork together with an own subnet address, thereby notifying the apparatus to be set of information required for communication including the subnet address and the node address.

However, in the address setting method described in Japanese Patent Application Laid-open Nos. 2003-209551 and 2004-48175, it is assumed that the subnet address has been set, and a method of easily setting the subnet address is not disclosed.

In the method described in Japanese Patent Application Laid-open No. 2003-46519, the setting apparatus can easily assign the same subnet address as that of an existing apparatus to a communication apparatus whose address has not been set. However, when a new group is constructed, a method of easily giving the subnet address to the communication apparatus whose address has not been set is not disclosed.

In the method described in Japanese Patent Application Laid-open No. 2003-46519, the setting apparatus broadcasts information required for communication including the subnet address and the node address, and the communication apparatus having no set address, which has received the information, sets the received information. Therefore, for example, when there is a plurality of apparatuses whose addresses have not been set, such as immediately after construction of a new group, the same address is set to all of these apparatuses, and therefore communication thereafter may not be performed normally.

### SUMMARY OF THE INVENTION

It is an object of the present invention to at least partially solve the problems in the conventional technology.

According to an aspect of the present invention, a communication apparatus that constitutes a communication system including a group of communication apparatuses, in which the group is identified by a first identifier, and each of the communication apparatuses is identified by a second identifier, includes a storage unit that is configured to store therein a first identifier of a group to which the communication apparatus belongs, a control unit that controls, when no first identifier has been set for the communication apparatus, exchange of signals for setting a first identifier, and a broadcasting unit that broadcasts, under control of the control unit, a first-identifier request signal to other communication apparatuses so as to be notified of a first identifier. Upon receipt of a first-identifier notification signal that includes a first identifier in response to the first-identifier request signal, the control unit stores the first identifier in the storage unit for use in communication.

According to another aspect of the present invention, a communication apparatus that constitutes a communication system including a group of communication apparatuses, in which the group is identified by a first identifier, and each of the communication apparatuses is identified by a second identifier, includes a control unit that controls, upon receipt of a first-identifier request signal for requesting notification of a first identifier from another communication apparatus for which no first identifier has been set, exchange of signals for notifying the other communication apparatus of a first identifier, an input unit that receives a notification instruction to broadcast a first-identifier notification signal that includes a first identifier, and a broadcasting unit that broadcasts, under control of the control unit, a first-identifier notification signal according to the notification instruction in response to the first-identifier request signal.

According to still another aspect of the present invention, a communication system that includes a group of communication apparatuses, in which the group is identified by a first identifier, and each of the communication apparatuses is identified by a second identifier, includes a first communication apparatus and a second communication apparatus. The first communication apparatus, for which no first identifier has been set, includes a storage unit that is configured to store therein a first identifier, a first control unit that controls exchange of signals for setting a first identifier, and a first broadcasting unit that broadcasts, under control of the first control unit, a first-identifier request signal to other communication apparatuses so as to be notified of a first identifier. The second communication apparatus includes a second control unit that controls, upon receipt of the first-identifier request signal from the first communication apparatus, exchange of signals for notifying the first communication apparatus of a first identifier, an input unit that receives a notification instruction to broadcast a first-identifier notification signal that includes a first identifier, and a second broadcasting unit that broadcasts, under control of the second control unit, a first-identifier notification signal according to the notification instruction in response to the first-identifier request signal. Upon receipt of the first-identifier notification signal in response to the first-identifier request signal, the first control unit stores the first identifier in the storage unit for use in communication.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a communication apparatus according to a first embodiment of the present invention;

FIG. 2 is an example of an address used for communication by the communication apparatus;

FIG. 3 is an example of a data frame used for communication by the communication apparatus;

FIG. 4 is an example of a field after a frame code in the data frame of control information;

FIG. 5 is a flowchart of the operation of the communication apparatus according to the first embodiment;

FIG. 6 is a flowchart of the operation of a communication apparatus according to a second embodiment of the present invention;

FIG. 7 is a block diagram of a communication apparatus according to a third embodiment of the present invention;

FIG. 8 is a flowchart of the operation of the communication apparatus according to the third embodiment;

FIG. 9 is a block diagram of a communication apparatus according to a fourth embodiment of the present invention;

FIG. 10 is a flowchart of the operation of the communication apparatus according to the fourth embodiment;

FIG. 11 is a flowchart of the operation of a communication apparatus according to a fifth embodiment of the present invention;

FIG. 12 is a flowchart of the operation of a communication apparatus according to a sixth embodiment of the present invention;

FIG. 13 is a flowchart of the operation of a communication apparatus according to a seventh embodiment of the present invention;

FIG. 14 a sequence chart of the operation of a communication system according to an eighth embodiment of the present invention;

FIG. 15 is a block diagram of a communication apparatus according to a ninth embodiment of the present invention;

FIG. 16 is a flowchart of the operation of the communication apparatus according to the ninth embodiment;

FIG. 17 is a block diagram of a communication apparatus according to a tenth embodiment of the present invention;

FIG. 18 is a flowchart of the operation of the communication apparatus according to the tenth embodiment;

FIG. 19 is a sequence chart of the operation of a communication system according to an eleventh embodiment of the present invention;

FIG. 20 is a schematic diagram for explaining the operation of the communication system according to the eleventh embodiment;

FIG. 21 is a block diagram of a communication apparatus according to a twelfth embodiment of the present invention;

FIG. 22 is a flowchart of the operation of the communication apparatus according to the twelfth embodiment;

FIG. 23 is a block diagram of a communication apparatus according to a thirteenth embodiment of the present invention;

FIG. 24 is a block diagram of a communication apparatus according to a fourteenth embodiment of the present invention;

FIG. 25 is a block diagram of a communication apparatus according to a fifteenth embodiment of the present invention;

FIG. 26 is a flowchart of the operation of the communication apparatus according to the fifteenth embodiment;

FIG. 27 is a flowchart of the operation of a communication apparatus according to a sixteenth embodiment of the present invention; and

FIG. 28 a sequence chart of the operation of a communication system according to a seventeenth embodiment of the present invention.

### DETAILED DESCRIPTION OF THE PREFERRED EMBODIMENTS

Exemplary embodiments of the present invention are described in detail below with reference to the accompanying drawings.

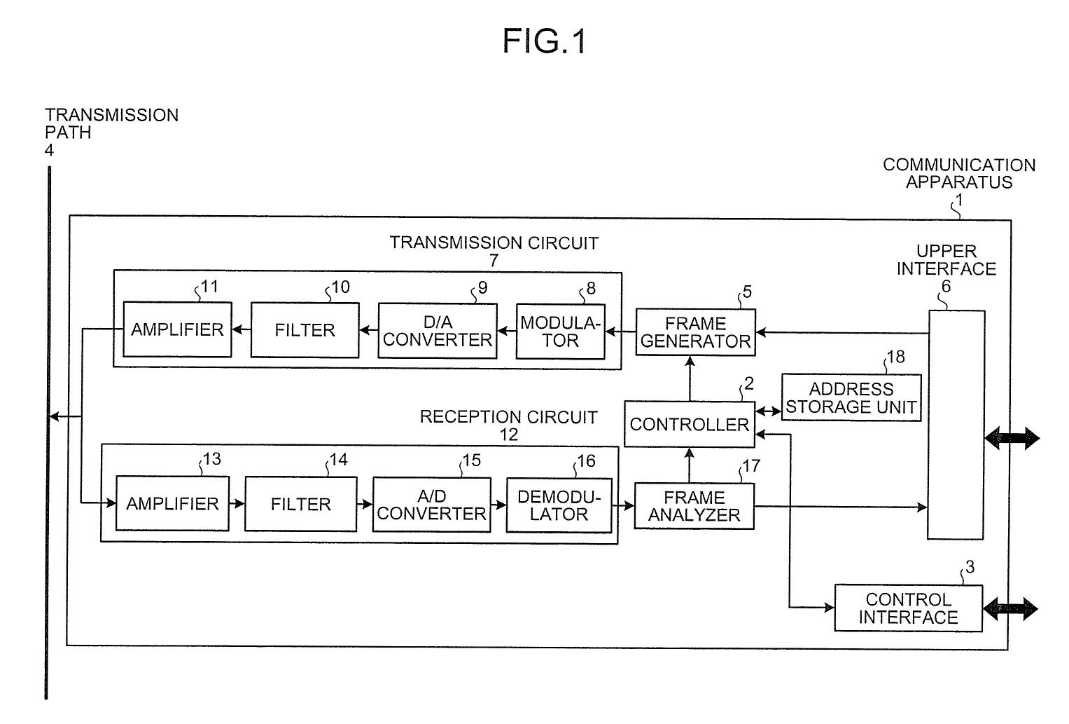

FIG. 1 is a block diagram of a communication apparatus 1 according to a first embodiment of the present invention. The communication apparatus 1 includes a controller 2, a control interface 3, a frame generator 5, an upper interface 6, a transmission circuit 7, a reception circuit 12, a frame analyzer 17, and an address storage unit 18.

The controller 2 is an arithmetic circuit such as a central processing unit (CPU) that controls an operation of the communication apparatus 1 based on an internal state of the communication apparatus 1, a control signal input from the control interface 3, and control information included in a reception signal received from a transmission path 4. The frame generator 5 generates a data frame to be transmitted to the transmission path 4 from transmission data transmitted from the upper interface 6 or a control-information transmission request notified from the controller 2. The transmission circuit 7 converts the data frame generated by the frame generator 5 to a signal in a format transmitted to the transmission path. According to a first embodiment of the present invention, the transmission circuit 7 is formed of a modulator 8 such as a multicarrier or an orthogonal frequency division multiplexing (OFDM) modulator, a digital-to-analog (D/A) converter 9 that converts a digital signal to an analog signal, a filter 10 that removes unnecessary components in the analog signal to be transmitted, and a amplifier 11 that amplifies power of the transmission signal.

The reception circuit 12 restores the signal received from the transmission path to the data frame, and is formed of a amplifier 13 that amplifies the received signal, a filter 14 that removes a noise component from the received analog signal, an analog-to-digital (A/D) converter 15 that converts an analog signal to a digital signal, and a demodulator 16 that demodulates a signal demodulated to the multicarrier or OFDM signal. The frame analyzer 17 analyzes the received data frame and transmits the control information obtained as the analysis result and the received data to the controller 2 and the upper interface 6. The address storage unit 18 stores an address of the apparatus according to the first embodiment, as the address of the apparatus, an address including at least a first identifier for identifying a group to which the apparatus belongs and a second identifier for specifying an individual apparatus is used.

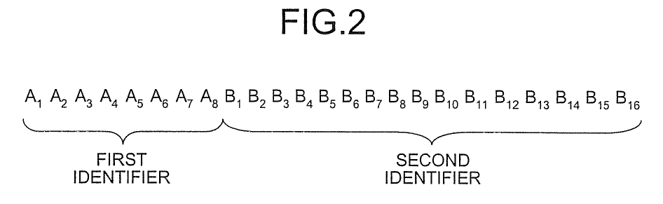

FIG. 2 is an example of an address used for communication by the communication apparatus 1. In this example, the address has a 24-bit length, where high-order 8 bit (A₁A₂A₃A₄A₅A₆A₇A₈) indicates the first identifier allocated for each group and low-order 16 bit (B₁B₂B₃B₄B₅B₆B₇B₈B₉B₁₀B₁₁B₁₂B₁₃B₁₄B₁₅B₁₆) indicates the second identifier allocated for each apparatus so as not to be duplicated in the same group.

A₁A₂A₃A₄A₅A₆A₇A₈=00000000 is prohibited to be allocated to a specific group, and is used as the first identifier of a destination address at the time of transmission in a predetermined broadcast function and the first identifier of a source addresssource address when the apparatus, whose address has not been set, transmits the control information and the like.

B₁B₂B₃B₄B₅B₆B₇B₈B₉B₁₀B₁₁B₁₂B₁₃B₁₄B₁₅B₁₆=0000000000000000 is prohibited to be allocated to a specific apparatus, and is used as the second identifier of a destination address at the time of transmission in the predetermined broadcast function and the second identifier of a source addresssource address when the apparatus, whose address has not been set, transmits the control information and the like.

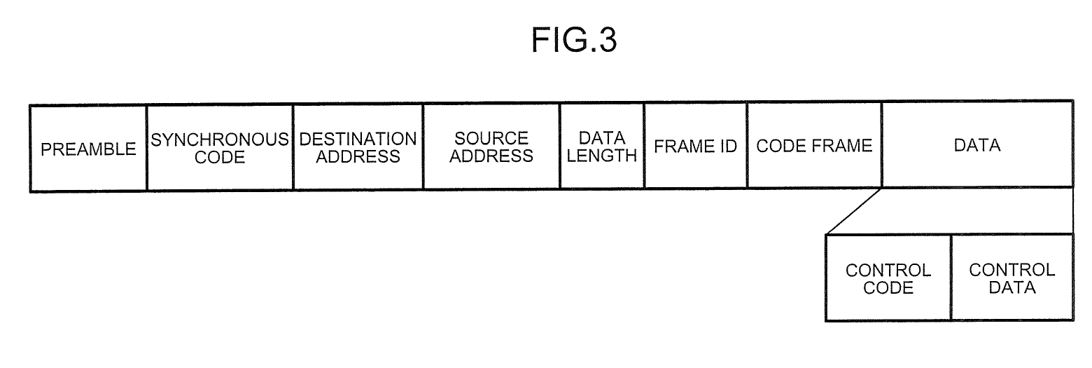

FIG. 3 is an example of a data frame used for communication by the communication apparatus 1. The data frame is formed of a preamble used for detecting a communication signal, a synchronous code for synchronizing demodulation timing at the time of demodulating the signal, the destination address for specifying the destination of the data frame, the source addresssource address for specifying the sender of the data frame, data length for specifying the size of the data to be transmitted, a frame ID for identifying the individual data frame, a frame code for identifying a type of the frame, and the data to be transmitted.

The frame ID is an 8-bit value, and the respective apparatuses use a value arbitrarily generated at the time of transmitting the data frame for the first time, and thereafter, use a value obtained by adding 1 to the frame ID used last time, every time the data frame is transmitted. After a series of bits 11111111 is used as the frame ID, a series of bits 00000000 is used at the time of transmitting the data frame next.

The frame code is a 1-bit value, and is set to 0 when general data is transmitted, and set to 1 when the control information for controlling the operation of another communication apparatus. The data contains arbitrary data in the data frame having the frame code of 0, and control code indicating the type of the control information to be transmitted and control data determined for each type of the control information in the data frame having the frame code of 1.

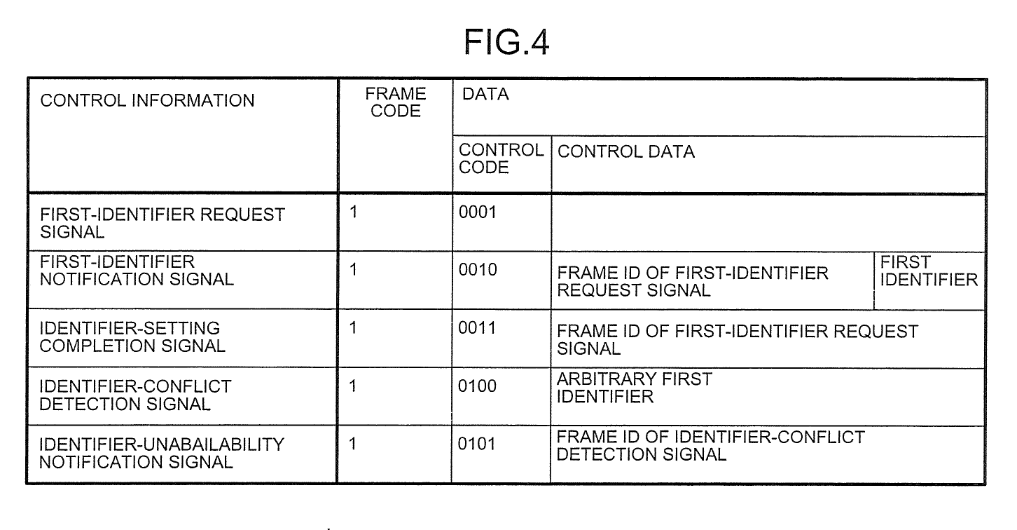

FIG. 4 is an example of a field after a frame code in the data frame of the control information. In the example of FIG. 4, the control information includes signals such as first-identifier request signal for requesting notification of a first identifier, first-identifier notification signal for notifying a first identifier, identifier-setting completion signal for notifying completion of setting a first identifier, identifier-conflict detection signal for notifying an arbitrarily generated first identifier, and identifier-unavailability notification signal for notifying an arbitrarily generated first identifier is already used. A first-identifier request signal contains a control code 0001 without control data. A first-identifier notification signal contains a control code 0010, and control data including a frame ID of a first-identifier request signal and a first identifier to be notified. An identifier-setting completion signal contains a control code 0011, and control data including a frame ID of a first-identifier request signal. An identifier-conflict detection signal contains a control code 0100, and control data including an arbitrarily generated first identifier to be notified. An identifier-unavailability notification signal contains a control code 0101, and control data including a frame ID of an identifier-conflict detection signal.

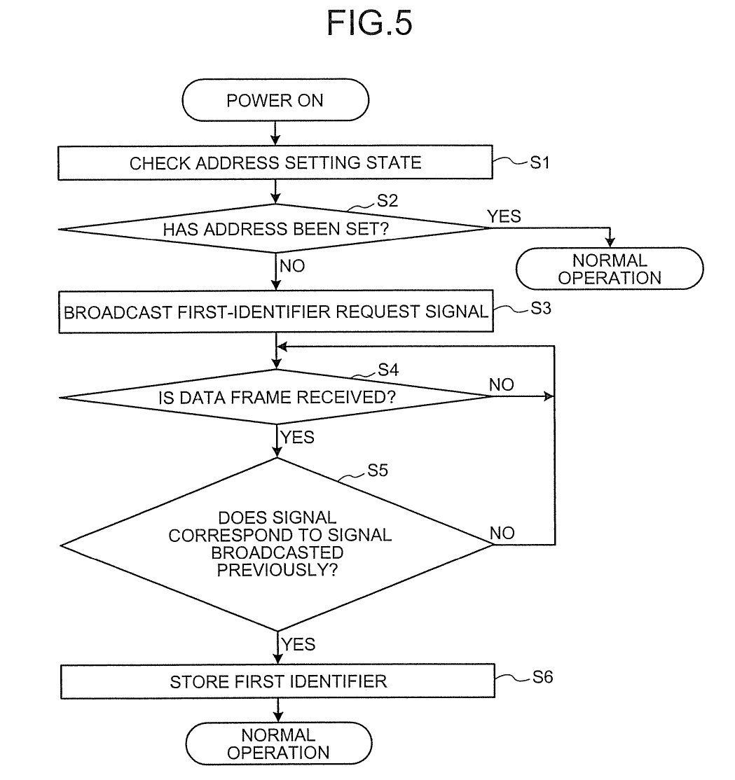

FIG. 5 is a flowchart of the operation of the communication apparatus 1 according to the first embodiment.

The controller 2 refers to the address storage unit 18 at the time the communication apparatus 1 is turned on to check address setting state (step S1). When the address of the communication apparatus 1 is not stored in the address storage unit 18 (NO at step S2), the controller 2 instructs the frame generator 5 to broadcast a first-identifier request signal to other apparatuses. The frame generator 5 generates a data frame of the first-identifier request signal and sends the data frame to the transmission circuit 7. The transmission circuit 7 modulates the data frame, converts the data frame to an analog signal, removes unnecessary components therefrom, and amplifies the signal power to transmit the analog signal to the transmission path 4 (step S3).

If the address of the communication apparatus 1 is stored in the address storage unit 18 (YES at step S2), the controller 2 performs a normal operation.

After broadcasting the first-identifier request signal, the communication apparatus 1 waits for receiving a first-identifier notification signal in response to the broadcast first-identifier request signal (step S4). Upon receipt of a first-identifier notification signal (YES at step S4), the frame analyzer 17 analyzes the data frame of the first-identifier notification signal. When the data frame has a frame code 1, and contains a control code 0010 and control data including a frame ID of a first-identifier request signal that matches that of the first-identifier request signal broadcasted previously (YES at step S5), the communication apparatus 1 stores the notified first identifier in the address storage unit 18 as its own first identifier (step S6).

According to the first embodiment, the communication apparatus 1, whose address has not been set, broadcasts a first-identifier request signal. In response to the broadcast first-identifier request signal, the communication apparatus 1 is notified of a first identifier, and stores the notified first identifier to use it for communication thereafter. Accordingly, a user can set the first identifier without troublesome operation of setting the first identifier. Thus, a possibility that a first address is wrongly set can be avoided.

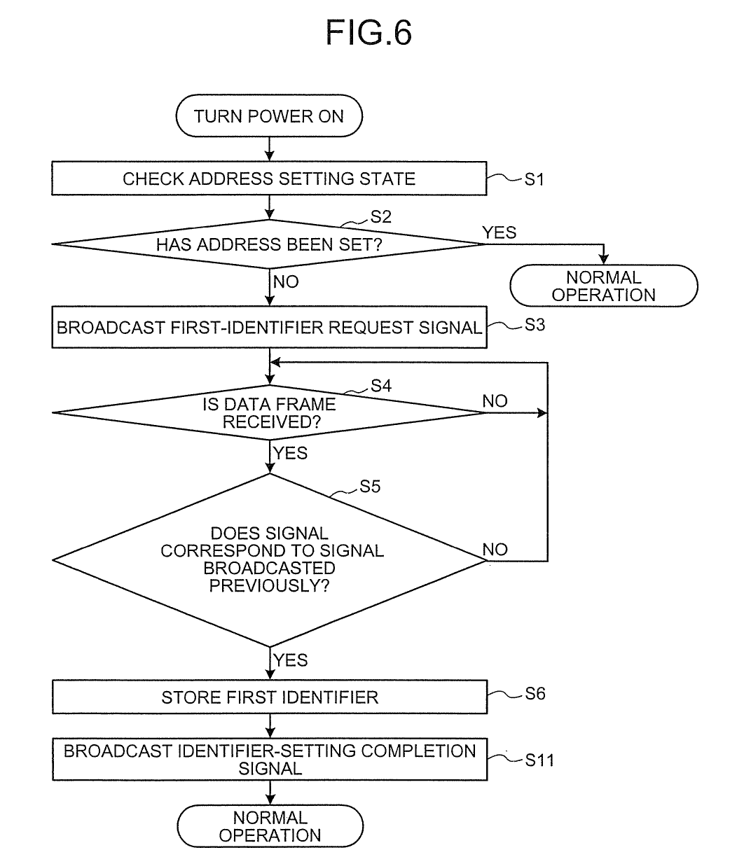

FIG. 6 is a flowchart of the operation of a communication apparatus according to a second embodiment of the present invention. The communication apparatus according to the second embodiment is of the same configuration and operates basically in a similar manner as the communication apparatus 1 shown in FIG. 1. Therefore, the same explanations are not repeated.

In FIG. 6, after the process from steps S1 to S6 previously described in connection with FIG. 5, an identifier-setting completion signal is broadcasted under the control of the controller 2.

In this manner, according to the second embodiment, the communication apparatus 1 notifies other apparatuses that setting of a first identifier is completed after the process in the first embodiment. Thus, the other apparatuses can recognize the completion of the address setting and avoid unnecessary transmission of a signal for notifying a first identifier.

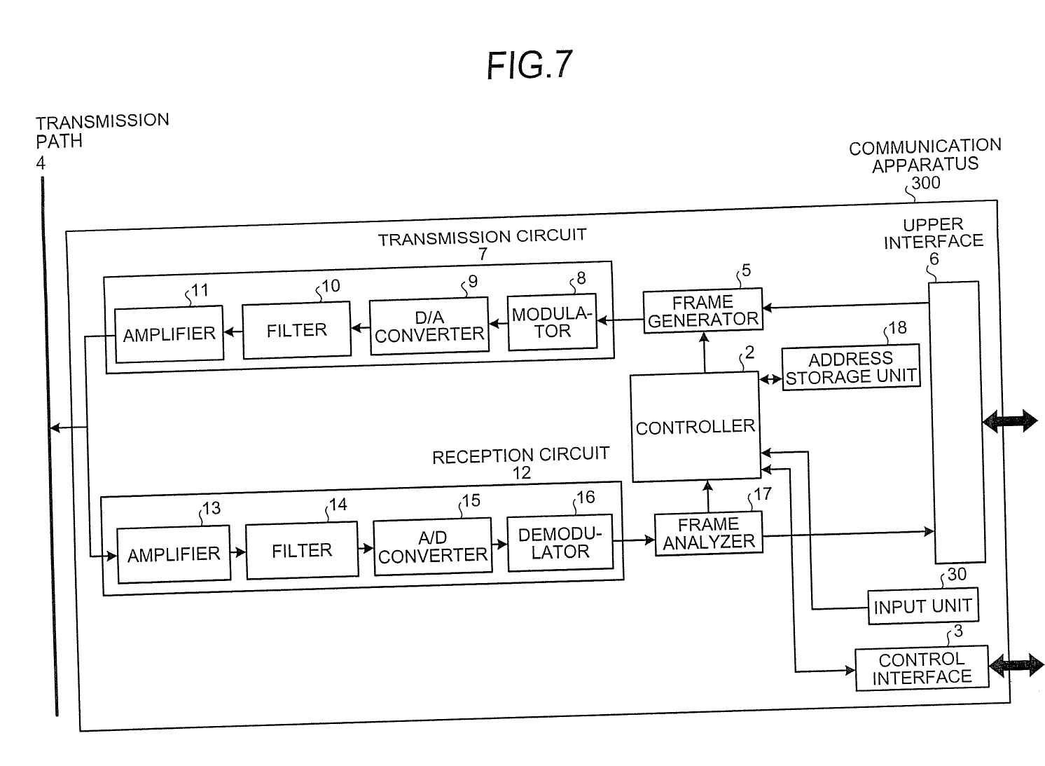

FIG. 7 is a block diagram of a communication apparatus 300 according to a third embodiment of the present invention. The communication apparatus 300 further includes an input unit 30 such as a push switch. Incidentally, like reference numerals refer to corresponding parts throughout the drawings, and the same explanations are not repeated.

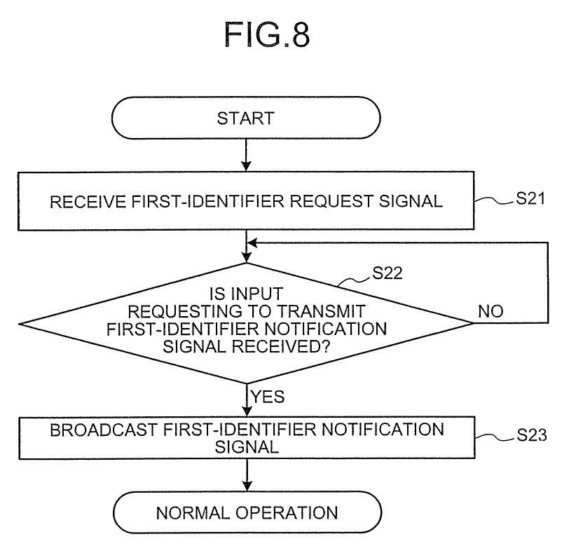

FIG. 8 is a flowchart of the operation of the communication apparatus 300. After receiving a first-identifier request signal from another apparatus (step S21), when receiving through the input unit 30 input requesting to transmit a first-identifier notification signal (YES at step S22), the communication apparatus 300 broadcasts a first-identifier notification signal (step S23). For example, the data frame of the first-identifier notification signal has a frame code 1, and contains a control code 0010 and control data including a frame ID of the first-identifier request signal and the first identifier of the communication apparatus 300. In this maimer, the communication apparatus 300 notifies the other apparatus of its own first identifier.

According to the third embodiment, having received a first-identifier request signal, the communication apparatus 300 notifies another apparatus of its own first identifier in response to input from the input unit 30. Accordingly, a user of the communication apparatus 300 can assign the same first identifier as its own identifier to a new apparatus without troublesome operation of inputting an address.

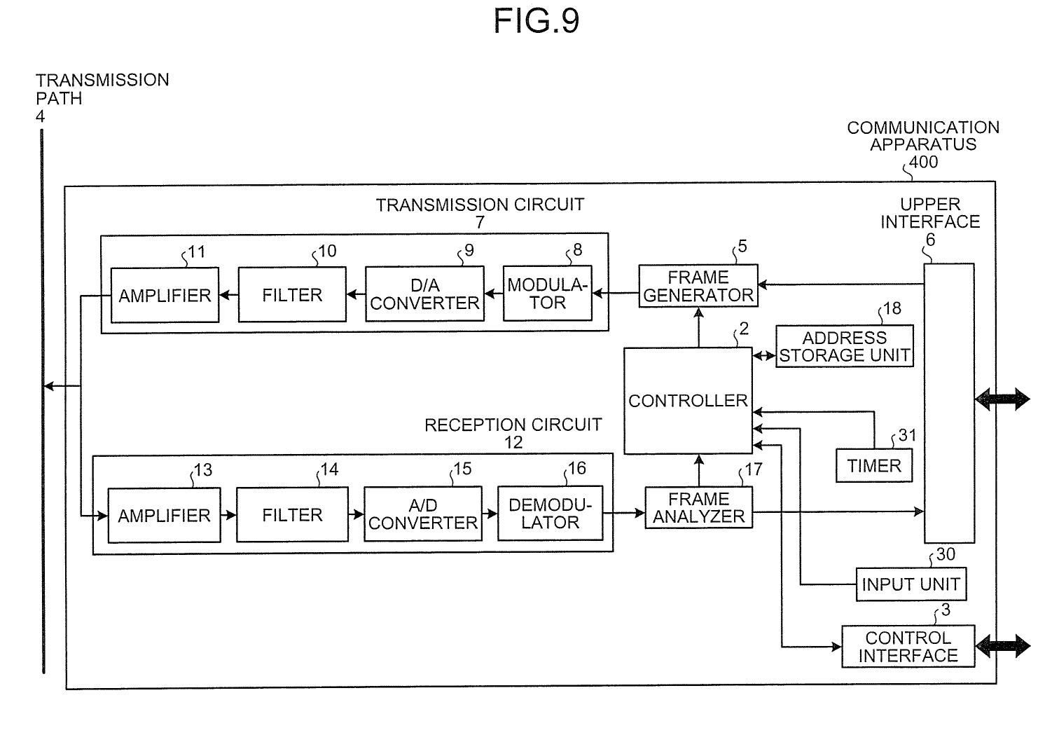

FIG. 9 is a block diagram of a communication apparatus 400 according to a fourth embodiment of the present invention. The communication apparatus 400 further includes a timer 31 that measures elapsed time since receipt of a first-identifier request signal.

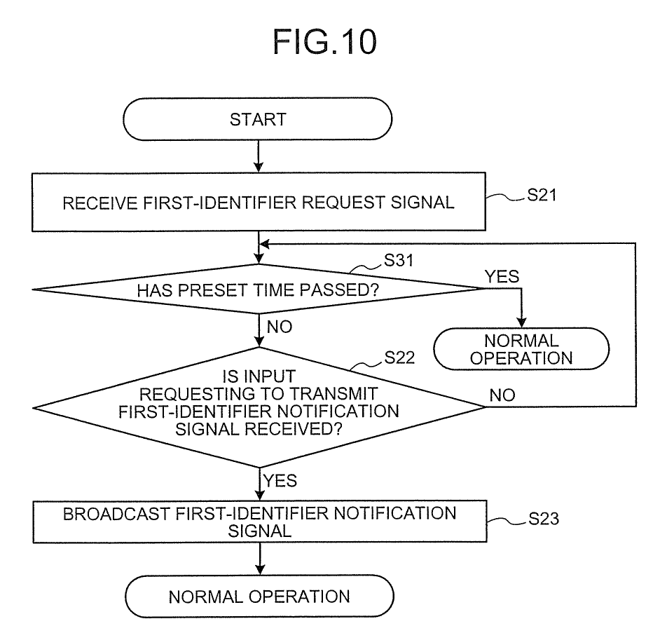

FIG. 10 is a flowchart of the operation of the communication apparatus 400. After receiving a first-identifier request signal under the control of the controller 2 (step S21), when receiving through the input unit 30 input requesting to transmit a first-identifier notification signal before a preset time has passed (NO at step S31, YES at step S22), the communication apparatus 400 performs the process at step S23 previously described in connection with FIG. 8.

On the other hand, when the preset time has already been passed (YES at step S31), the communication apparatus 400 ignores the input received through the input unit 30, and does not respond to the first-identifier request signal.

According to the fourth embodiment, when a preset time has passed after receipt of a first-identifier request signal, input requesting to transmit a first-identifier notification signal is invalidated. Accordingly, unnecessary transmission of a signal due to incorrect input or the like by a user can be prevented.

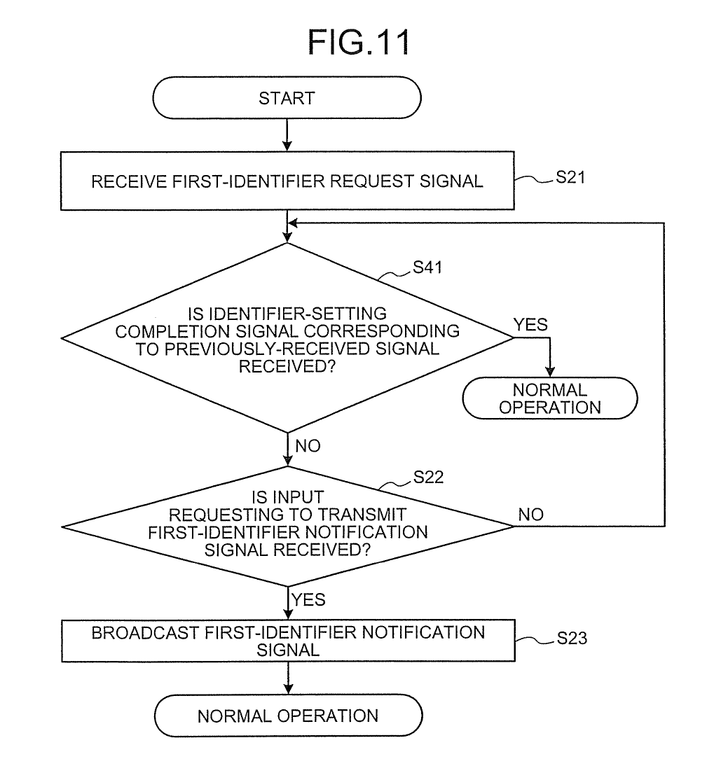

FIG. 11 is a flowchart of the operation of a communication apparatus according to a fifth embodiment of the present invention. The communication apparatus according to the fifth embodiment is of the same configuration and operates basically in a similar maimer as the communication apparatus 300 shown in FIG. 7. Therefore, the same explanations are not repeated.

After receiving a first-identifier request signal (step S21), when receiving through the input unit 30 input requesting to transmit a first-identifier notification signal before receiving an identifier-setting completion signal (NO at step S41, YES at step S22), the communication apparatus according to the fifth embodiment performs the process at step S23 previously described in connection with FIG. 8.

On the other hand, when receiving an identifier-setting completion signal after receiving a first-identifier request signal, the communication apparatus according to the fifth embodiment checks the field of control data contained in the identifier-setting completion signal. If the control data of the identifier-setting completion signal includes a frame ID that matches that of the first-identifier request signal. (YES at step S41), the communication apparatus ignores the input received through the input unit 30, and does not respond to the first-identifier request signal.

According to the fifth embodiment, when an identifier-setting completion signal is received after receipt of a first-identifier request signal, input requesting to transmit a first-identifier notification signal is invalidated. Accordingly, unnecessary transmission of a signal due to incorrect input or the like by a user can be prevented.

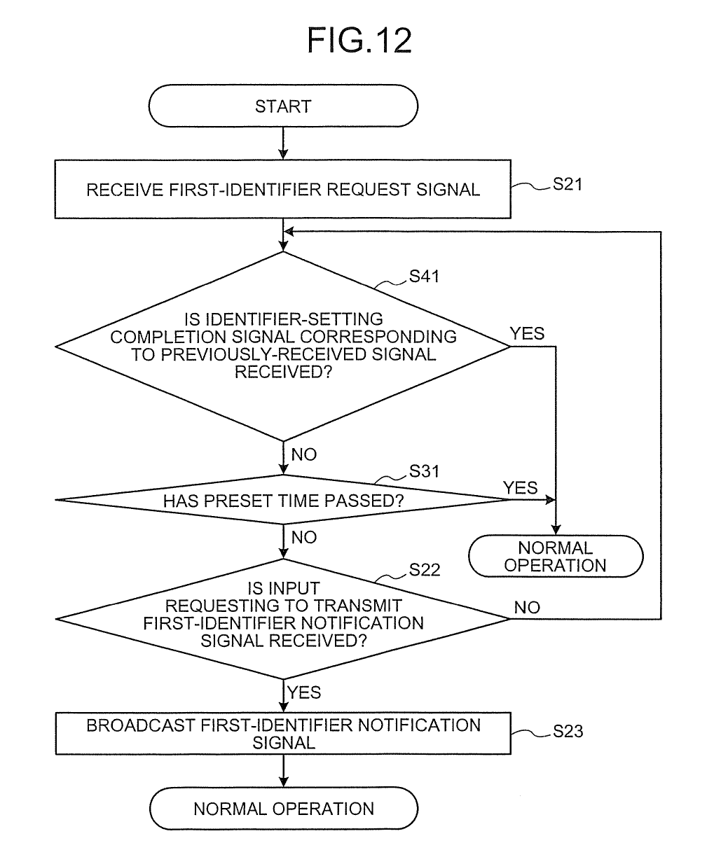

FIG. 12 is a flowchart of the operation of a communication apparatus according to a sixth embodiment of the present invention. The communication apparatus according to the sixth embodiment is of the same configuration and operates basically in a similar maimer as the communication apparatus 400 shown in FIG. 9. Therefore, the same explanations are not repeated.

After receiving a first-identifier request signal (step S21), when receiving through the input unit 30 input requesting to transmit a first-identifier notification signal before receiving an identifier-setting completion signal and before a preset time has passed (NO at step S41, NO at step S31, YES at step S22), the communication apparatus according to the sixth embodiment performs the process at step S23 previously described in connection with FIG. 8.

On the other hand, when receiving an identifier-setting completion signal after receiving a first-identifier request signal, the communication apparatus according to the sixth embodiment checks the field of control data contained in the identifier-setting completion signal. If the control data of the identifier-setting completion signal includes a frame ID that matches that of the first-identifier request signal. (YES at step S41), the communication apparatus ignores the input received through the input unit 30. If the frame ID does not match that of the first-identifier request signal (NO at step S41), the communication apparatus checks whether the preset time has passed. When the preset time has already been passed (YES at step S31), the communication apparatus ignores the input received through the input unit 30, and does not respond to the first-identifier request signal.

According to the sixth embodiment, when an identifier-setting completion signal is received and when a preset time has passed after receipt of a first-identifier request signal, input requesting to transmit a first-identifier notification signal is invalidated. Accordingly, unnecessary transmission of a signal due to incorrect input or the like by a user can be prevented.

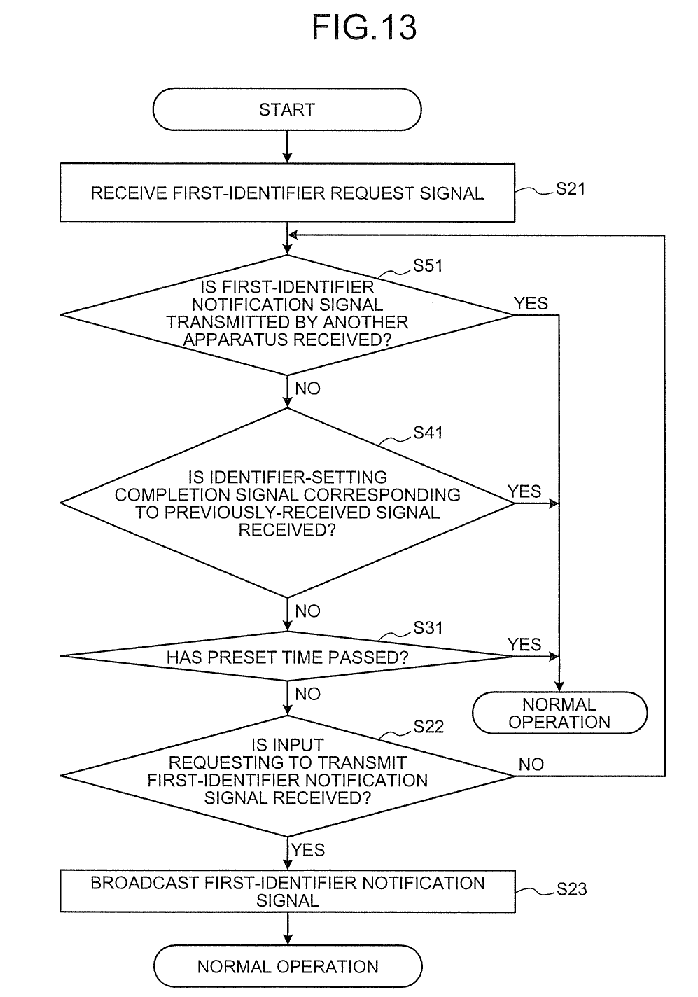

FIG. 13 is a flowchart of the operation of a communication apparatus according to a seventh embodiment of the present invention. The communication apparatus according to the seventh embodiment is of the same configuration and operates basically in a similar manner as the communication apparatus 400 shown in FIG. 9. Therefore, the same explanations are not repeated.

The process shown in FIG. 13 includes an additional condition for transmitting a first-identifier notification signal. That is, in addition to the aforementioned process (NO at steps S41, NO at step S31, and YES at step S22), having not received a first-identifier notification signal transmitted by another apparatus, which contains control data including a frame ID that matches that of the first-identifier request signal received at step S21 (NO at step S51), the communication apparatus according to the seventh embodiment broadcasts a first-identifier notification signal at step S23.

On the other hand, upon receipt of a first-identifier notification signal transmitted by another apparatus, which contains control data including a frame ID that matches that of the first-identifier request signal received at step S21 (YES at step S51), the communication apparatus ignores the input received through the input unit 30, and does not respond to the first-identifier request signal.

According to the seventh embodiment, when a first-identifier notification signal transmitted by another apparatus is received after receipt of a first-identifier request signal, input requesting to transmit a first-identifier notification signal is invalidated. Accordingly, unnecessary transmission of a signal due to incorrect input or the like by a user can be prevented.

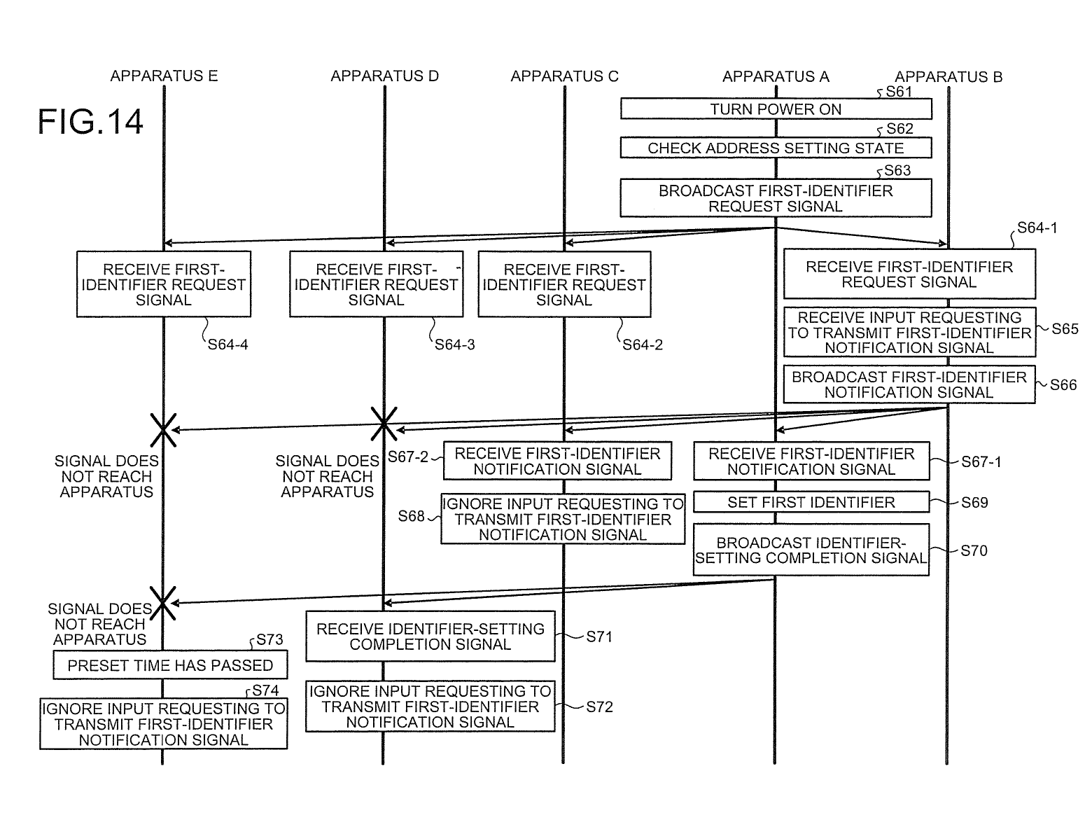

FIG. 14 is a sequence chart of the operation of a communication system according to an eighth embodiment of the present invention. In FIG. 14, for example and without limitation, an apparatus A is the communication apparatus according to the second embodiment, and apparatuses B, C, D, and E are the communication apparatus according to the seventh embodiment. The apparatus A can be the communication apparatus according to the first embodiment, and the apparatuses B, C, D, and E can be the communication apparatus according to any one of the third to sixth embodiments.

First, the apparatus A, which has been turned on (step S61), checks address setting state thereof (step S62), and broadcasts a first-identifier request signal (step S63).

After receiving the first-identifier request signal (step S64-1), the apparatus B receives input requesting to transmit a first-identifier notification signal (step S65). The apparatus B broadcasts the first-identifier notification signal in response to the input (step S66). The apparatus A receives the first-identifier notification signal transmitted by the apparatus B (step S67-1), stores a first identifier notified by the first-identifier notification signal in the address storage unit 18 (step S69), and broadcasts an identifier-setting completion signal (step S70).

On the other hand, after receiving the first-identifier request signal (step S64-2), the apparatus C receives the first-identifier notification signal transmitted by the apparatus B (step S67-2). Thus, the apparatus C ignores input requesting to transmit a first-identifier notification signal (step S68).

The apparatus D, which has received the first-identifier request signal (step S64-3) but could not receive the first-identifier notification signal transmitted by the apparatus B due to, for example, a communication error, receives the identifier-setting completion signal transmitted by the apparatus A (step S71), and ignores input requesting to transmit a first-identifier notification signal (step S72).

The apparatus E, which has received the first-identifier request signal (step S64-4), but could not receive the first-identifier notification signal transmitted by the apparatus B and the identifier-setting completion signal transmitted by the apparatus A due to, for example, a communication error, ignores input requesting to transmit a first-identifier notification signal (step S74) when a preset time has passed (step S73).

With this configuration, a user can assign the same first identifier as that of an existing apparatus to a new apparatus without troublesome operation of inputting an address. Accordingly, unnecessary transmission of a signal due to incorrect input or the like by a user can be prevented.

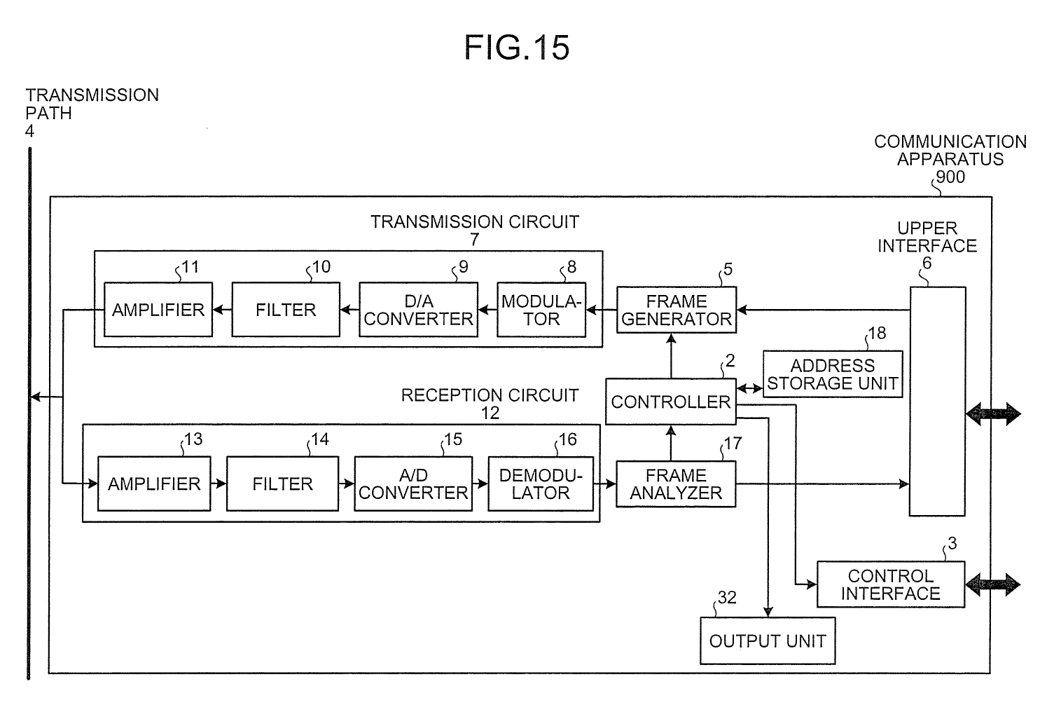

FIG. 15 is a block diagram of a communication apparatus 900 according to a ninth embodiment of the present invention. The communication apparatus 900 further includes an output unit 32 such as a light emitting diode (LED) indicating that the first identifier is in the process of being set.

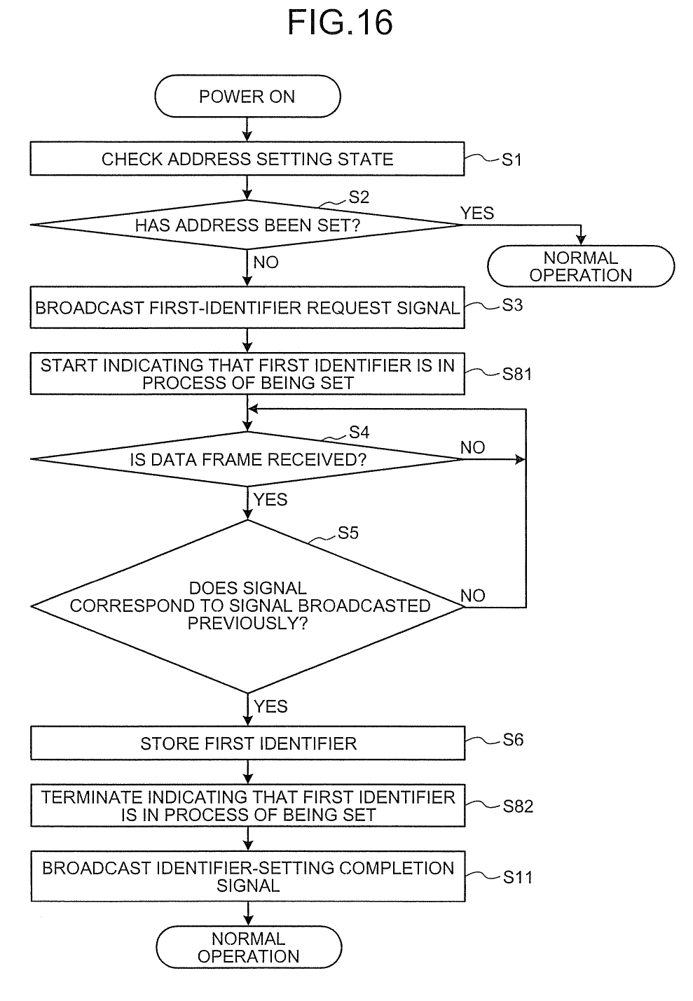

FIG. 16 is a flowchart of the operation of the communication apparatus 900. After broadcasting a first-identifier request signal (step S3), the communication apparatus 900 starts indicating by the output unit 32 that a first identifier is in the process of being set under the control of the controller 2 (step S81).

Thereafter, when a first identifier notified by the process at steps S4 to S6 is stored in the address storage unit 18, the communication apparatus 900 terminates the indication by the output unit 32 under the control of the controller 2 (step S82).

According to the ninth embodiment, during a procedure for setting a first identifier, the communication apparatus 900 indicates that a first identifier is in the process of being set. Accordingly, a user can determine whether the first identifier has been set and the process is normally complete.

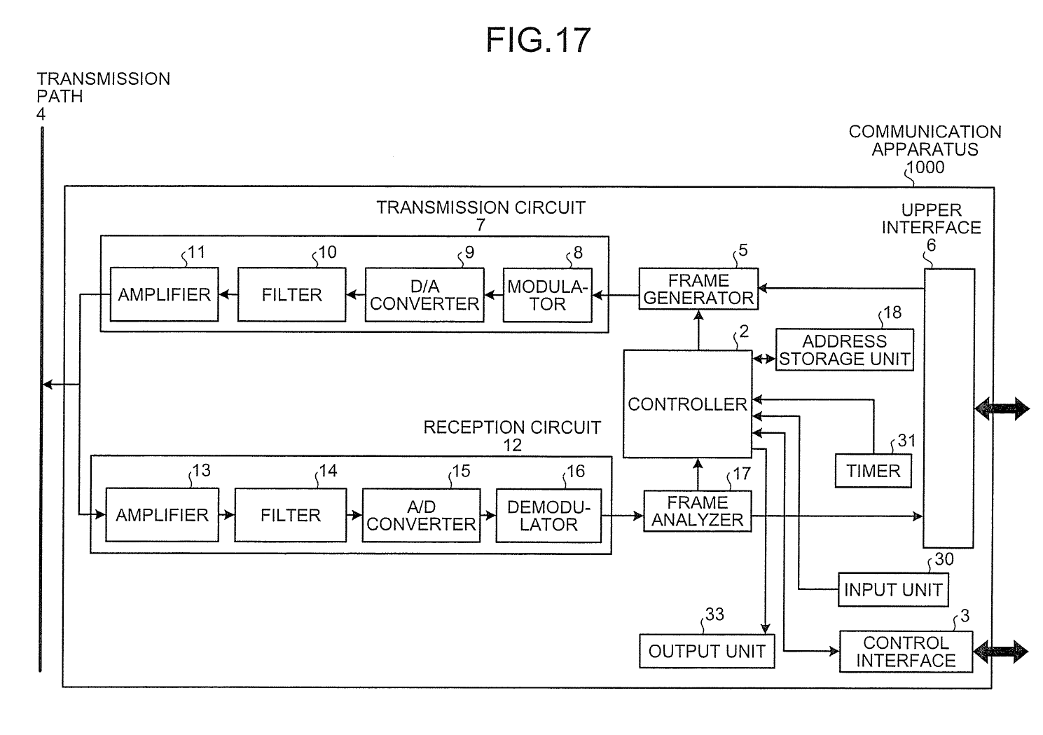

FIG. 17 is a block diagram of a communication apparatus 1000 according to a tenth embodiment of the present invention. The communication apparatus 1000 further includes an output unit 33 such as an LED indicating that a first-identifier notification signal has been transmitted.

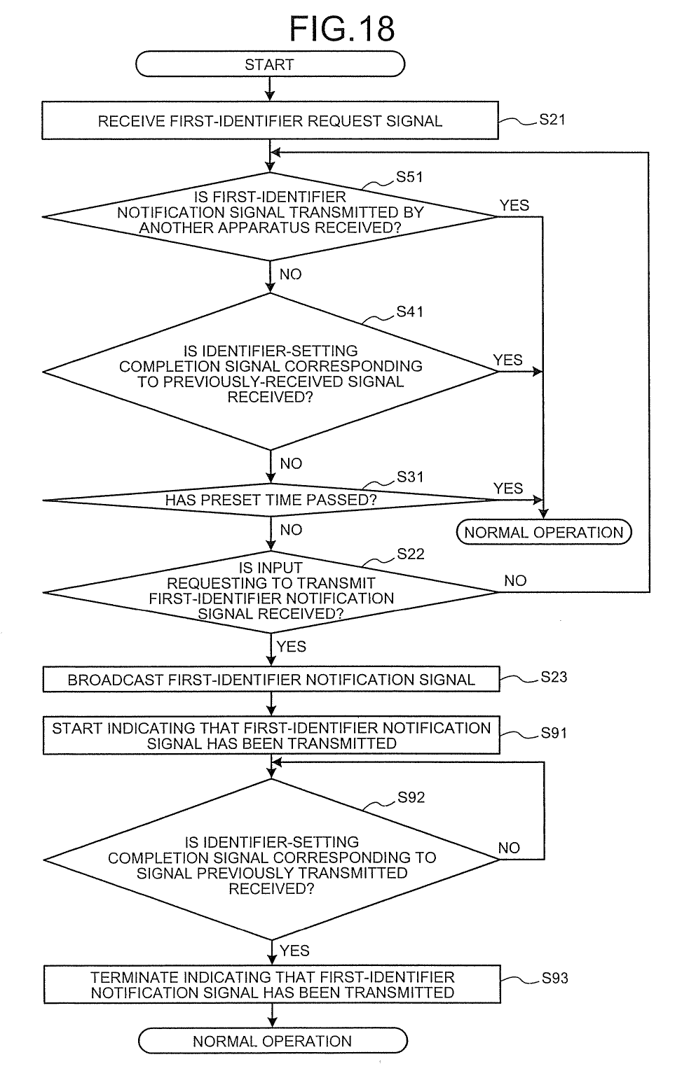

FIG. 18 is a flowchart of the operation of the communication apparatus 1000 applied to, for example, a case of the seventh embodiment. Upon receipt of a first-identifier request signal, the communication apparatus 1000 broadcasts a first-identifier notification signal as previously explained in the seventh embodiment (step S23). Thereafter, the communication apparatus 1000 starts indicating by the output unit 33 that the first-identifier notification signal has been transmitted under the control of the controller 2 (step S91), and waits for receiving an identifier-setting completion signal (NO at step S92).

Upon receipt of an identifier-setting completion signal corresponding to the first-identifier notification signal previously transmitted (YES at step S92), the communication apparatus 1 terminates the indication by the output unit 33 (step S93).

According to the tenth embodiment, during a period from transmission of a first-identifier notification signal until receipt of an identifier-setting completion signal in response thereto, the communication apparatus 1000 indicates that a first-identifier notification signal has been transmitted. Therefore, a user can determine whether the process is normally complete.

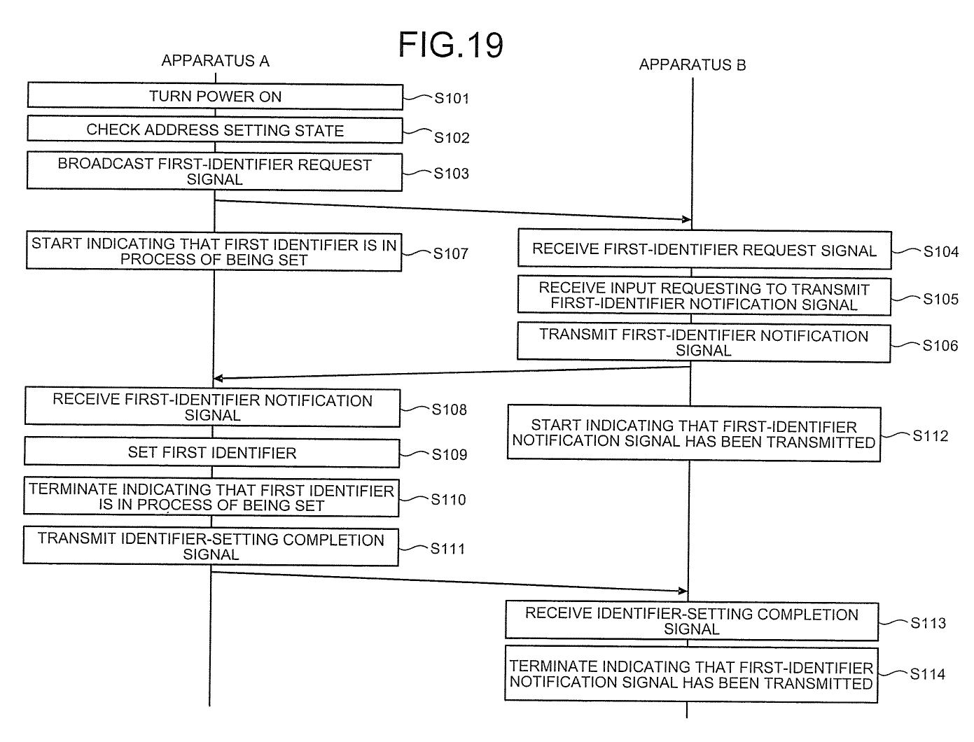

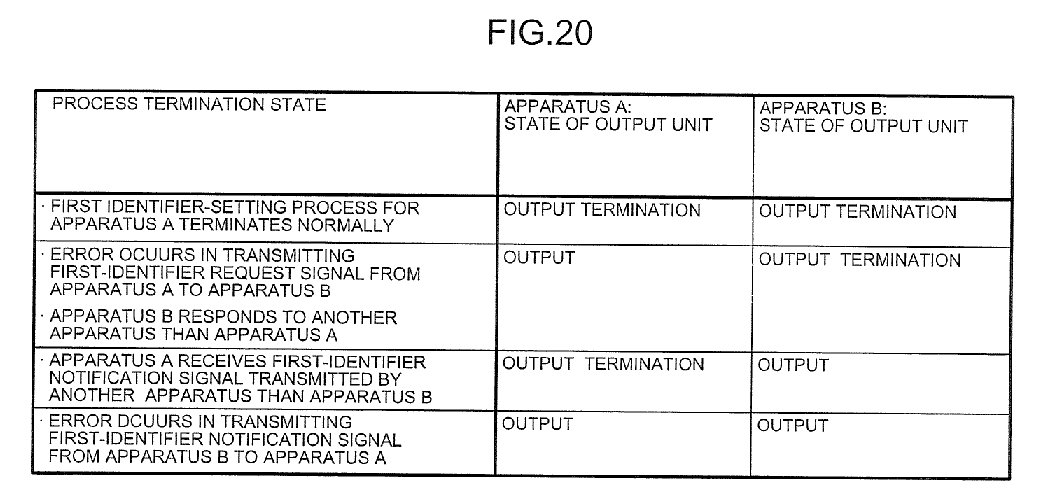

FIGS. 19 and 20 are a sequence chart and a schematic diagram for explaining the operation of a communication system according to an eleventh embodiment of the present invention. In FIGS. 19 and 20, for example and without limitation, an apparatus A is the communication apparatus according to the ninth embodiment, and an apparatus B is the communication apparatus according to the tenth embodiment.

First, the apparatus A, which has been turned on (step S101), checks address setting state thereof (step S102), and broadcasts a first-identifier request signal (step S103). The apparatus A starts indicating that a first identifier is in the process of being set (step S107), and waits for receiving a first-identifier notification signal.

On the other hand, after receiving the first-identifier request signal (step S104), the apparatus B receives input requesting to transmit a first-identifier notification signal (step S105). The apparatus B transmits the first-identifier notification signal in response to the input (step S106). The apparatus B then starts indicating that the first-identifier notification signal has been transmitted (step S112), and thereafter, waits for receiving an identifier-setting completion signal.

Upon receipt the first-identifier notification signal (step S108), the apparatus A stores a first identifier notified by the first-identifier notification signal in the address storage unit 18 (step S109), and terminates indicating that a first identifier is in the process of being set (step S110). The apparatus A then transmits an identifier-setting completion signal (step S111).

Upon receipt of the identifier-setting completion signal corresponding to the first-identifier notification signal (step S113), the apparatus B terminates indicating that the first-identifier notification signal has been transmitted (step S114).

The state of the output unit of the apparatus A and the apparatus B is explained specifically. For example, when the process for setting a first identifier is complete normally, indication by the output units of the apparatus A and the apparatus B are both terminated.

When the apparatus B cannot normally receive a first-identifier request signal transmitted from the apparatus A, the output unit of the apparatus B displays no indication, while the output unit of the apparatus A displays indication. When the apparatus A and another communication apparatus having the same function as that of the apparatus A substantially simultaneously transmit a first-identifier request signal, and the apparatus B transmits a first-identifier notification signal to the other communication apparatus in response to the first-identifier request signal therefrom, a first identifier is not set for the apparatus A. Consequently, the output unit of the apparatus B terminates indication, while the output unit of the apparatus A keeps displaying indication.

When another communication apparatus having the same function as that of the apparatus B transmits a first-identifier notification signal in response to a first-identifier request signal transmitted by the apparatus A, and a first identifier unintended by a user is set for the apparatus A, the output unit of the apparatus A terminates indication, while the output unit of the apparatus B keeps displaying indication.

When the apparatus A cannot normally receive a first-identifier notification signal transmitted from the apparatus B, and a first identifier is not set for the apparatus A, the output units of both the apparatus A and B keep displaying indication.

According to the eleventh embodiment the communication system includes, for example, the communication apparatus according to the ninth embodiment and the communication apparatus according to the tenth embodiment. With this configuration, a user can confirm whether a first identifier has been set properly.

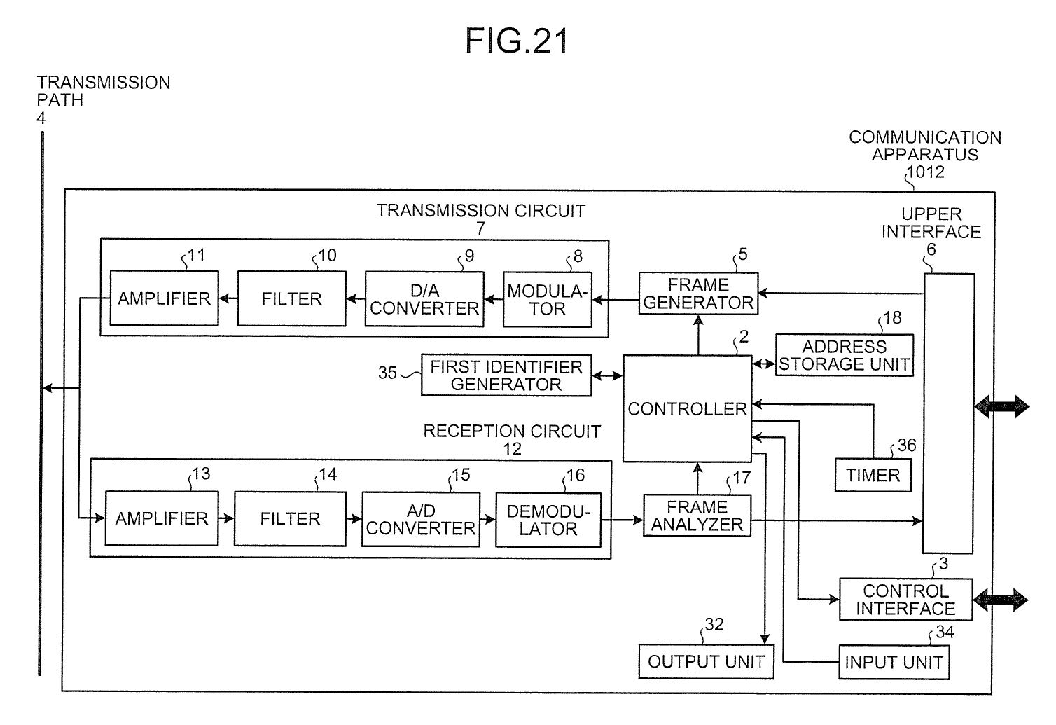

FIG. 21 is a block diagram of a communication apparatus 1012 according to a twelfth embodiment of the present invention. The communication apparatus 1012 further includes an input unit 34 used to start generating an arbitrary first identifier, a first identifier generator 35 that actually generates an arbitrary first identifier, and a timer 36 that measures elapsed time since transmission of an identifier-conflict detection signal.

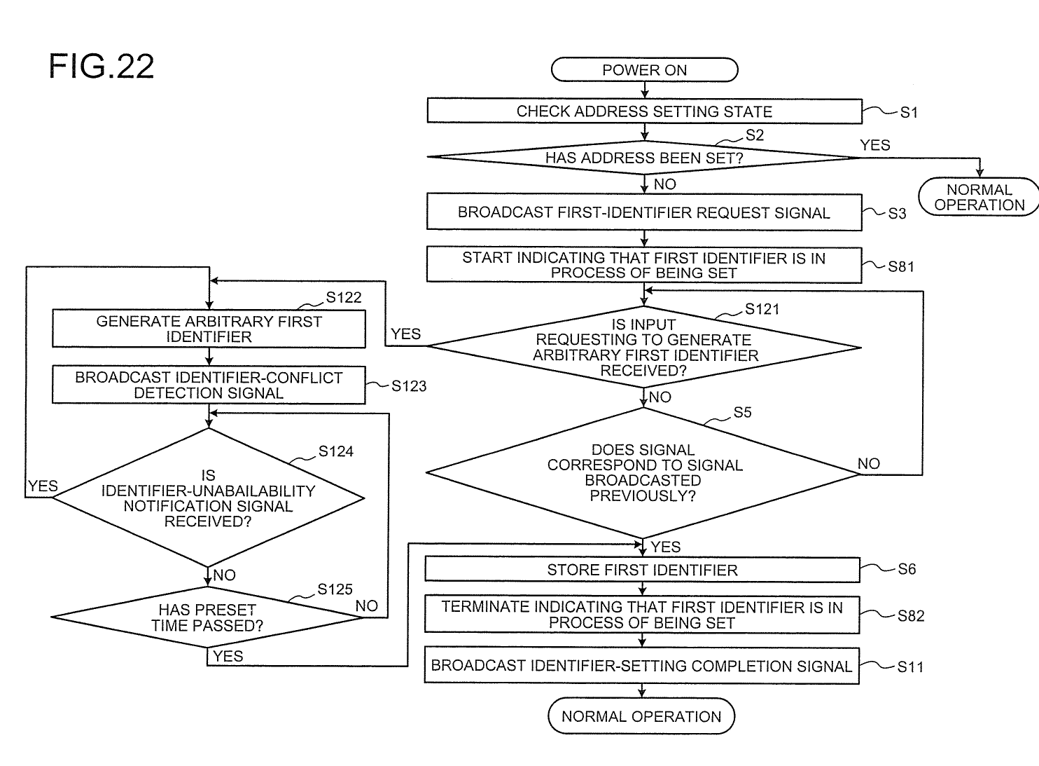

FIG. 22 is a flowchart of the operation of the communication apparatus 1012. In the communication apparatus 1012, after start of indicating that a first identifier is in the process of being set, as in, for example, the ninth embodiment (step S81), when input requesting to generate an arbitrary first identifier is received through the input unit 34 (YES at step S121) before receipt of a first-identifier notification signal, the first identifier generator 35 generates an arbitrary first identifier (step S122), and an identifier-conflict detection signal for notifying the arbitrary first identifier is broadcasted under the control of the controller 2 (step S123).

Thereafter, the communication apparatus 1012 measures the elapsed time after transmission of the identifier-conflict detection signal using the timer 36. If an identifier-unavailability notification signal is not received when a preset time has passed (NO at step S124), the communication apparatus 1012 stores the generated arbitrary first identifier in the address storage unit 18 (step S6), and uses the first identifier generated therein as its own first identifier.

On the other hand, if an identifier-unavailability notification signal is received before the preset time has passed since the transmission of the identifier-conflict detection signal (NO at step S125, YES at step S124), the communication apparatus 1012 repeatedly generates a new arbitrary first identifier and broadcasts an identifier-conflict detection signal for notifying a newly generated arbitrary first identifier until an identifier-unavailability notification signal is not received within the preset time. The communication apparatus 1012 thus stores the arbitrary first identifier if not receiving an identifier-unavailability notification signal (step S6), and uses the first identifier generated therein as its own first identifier.

According to the twelfth embodiment, the communication apparatus 1012 generates an arbitrary first identifier, and checks whether the generated arbitrary first identifier is already used as a first identifier of another communication apparatuses in the network. After checking that the arbitrarily generated first identifier is not used, the communication apparatus 1012 uses it for communication. A determination as to whether the above function is to be used is made based on input from a user. Thus, the user can classify a new communication apparatus in a group of existing communication apparatuses by setting the same first identifier as that of the existing communication apparatuses or create a new group to classify the new communication apparatus in the new group.

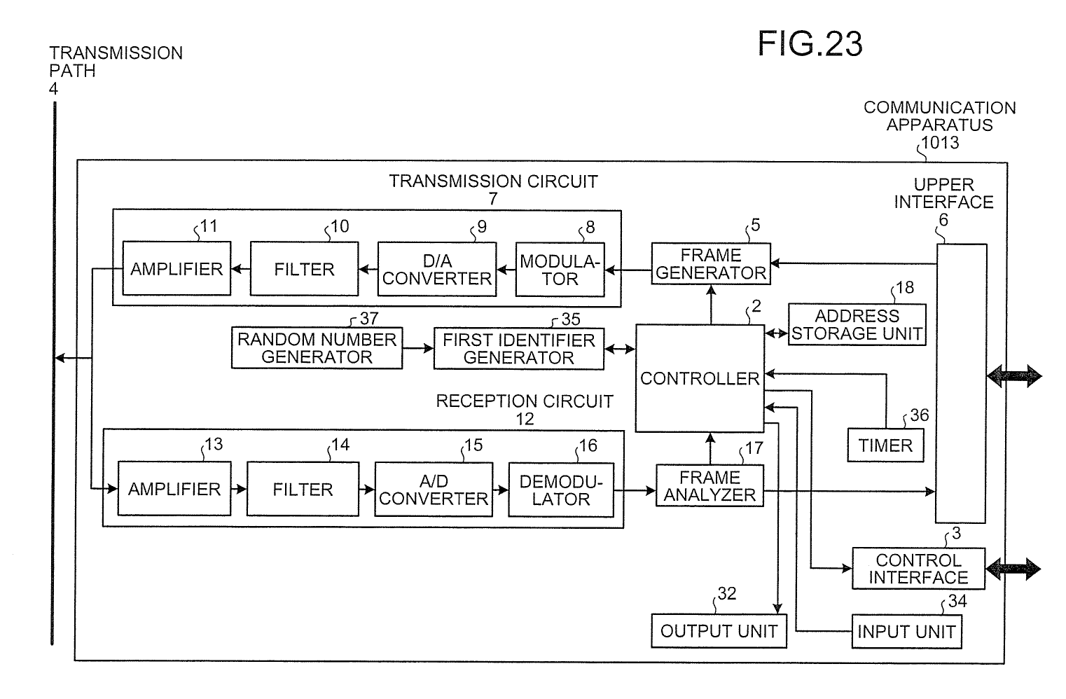

FIG. 23 is a block diagram of a communication apparatus 1013 according to a thirteenth embodiment of the present invention. The communication apparatus 1013 further includes a random number generator 37. The random number generator 37 inputs a random member to the first identifier generator 35, and the first identifier generator 35 generates an arbitrary first identifier based on the random number.

According to the thirteenth embodiment, an arbitrary first identifier is generated based on a random number. Accordingly, the generated arbitrary first identifier has a random value, which reduces a possibility that a first identifier that has already been used is generated. Therefore, the time required for setting a first identifier can be reduced.

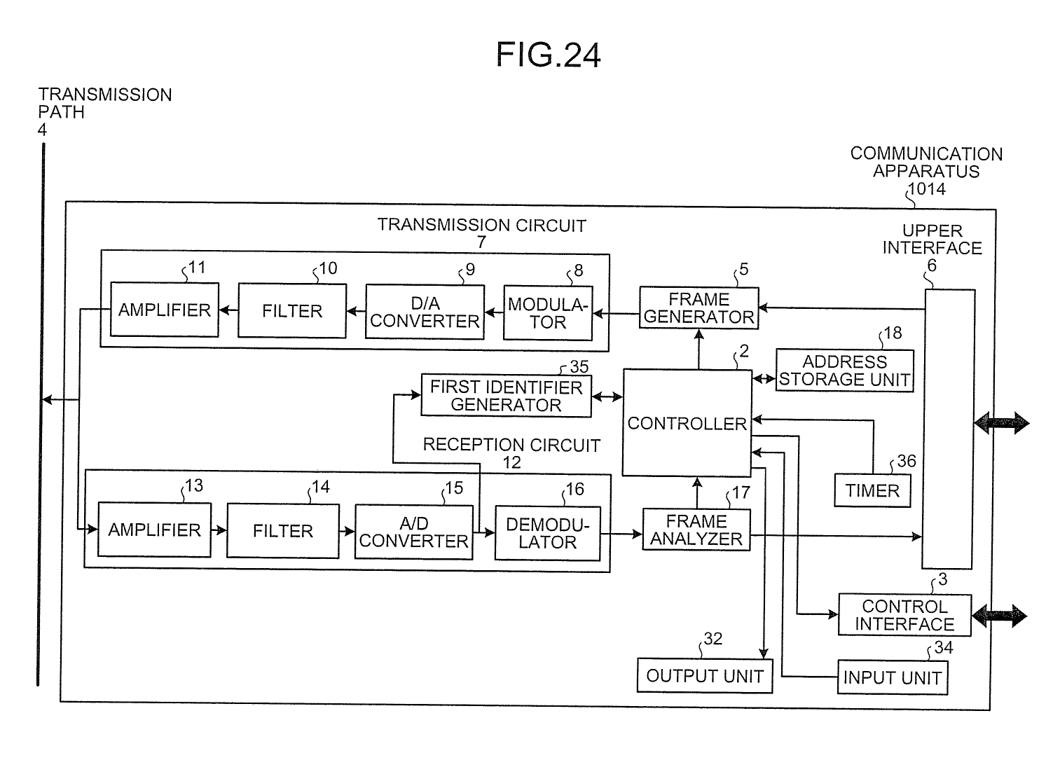

FIG. 24 is a block diagram of a communication apparatus 1014 according to a fourteenth embodiment of the present invention.

The communication apparatus 1014 inputs output of the A/D converter 15, which converts a signal voltage on a transmission path to digital information, to the first identifier generator 35. The first identifier generator 35 generates an arbitrary first identifier by combining part or all of bits of the output of the A/D converter 15. Because there is noise on the transmission path, the signal voltage on the transmission path having converted to the digital information by the A/D converter 15 at arbitrary timing fluctuates irregularly according to the conversion timing. Therefore, the arbitrary first identifier generated by combining part or all of bits of the output of the A/D converter 15 has a random value.

According to the fourteenth embodiment, the communication apparatus 1014 generates an arbitrary first identifier by combining part or all of bits of a result of conversion of a signal voltage on the transmission path to digital information. Therefore, an arbitrary first identifier having a random value can be easily obtained.

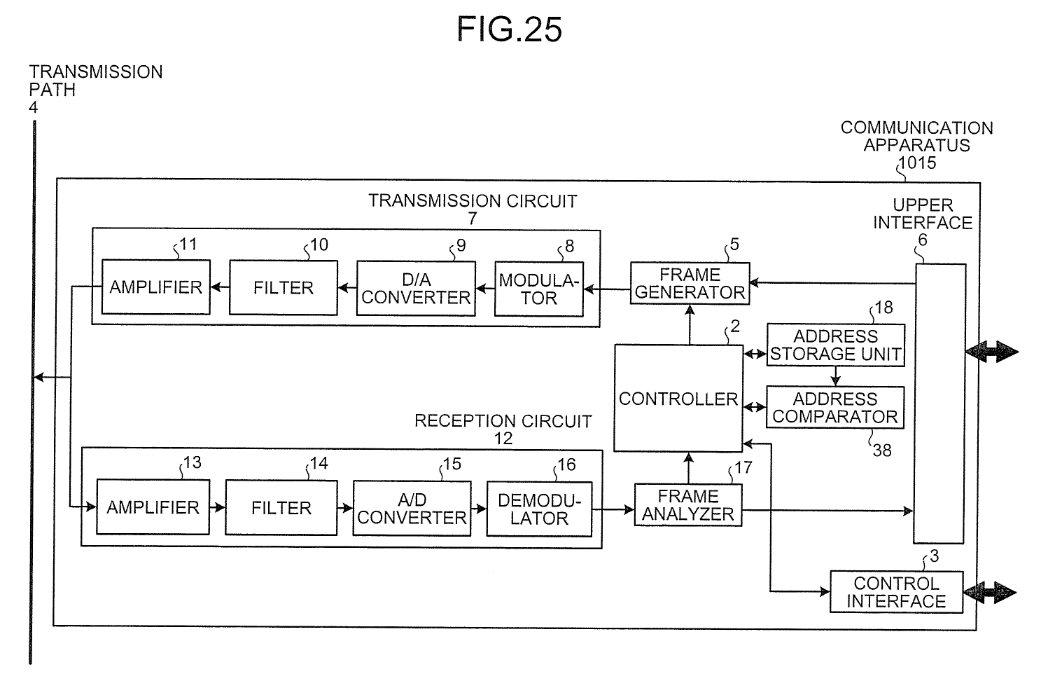

FIG. 25 is a block diagram of a communication apparatus 1015 according to the fifteenth embodiment. The communication apparatus 1015 further includes an address comparator 38 that compares an arbitrarily generated first identifier notified by an identifier-conflict detection signal with its own first identifier.

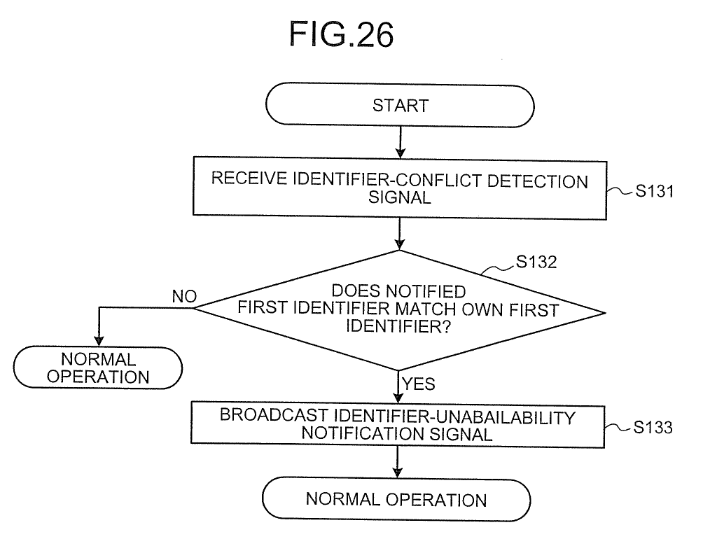

FIG. 26 is a flowchart of the operation of the communication apparatus 1015. Upon receipt of an identifier-conflict detection signal, the address comparator 38 compares an arbitrary first identifier notified by the identifier-conflict detection signal with a first identifier of the communication apparatus 1015. When the arbitrary first identifier matches the first identifier of the communication apparatus 1015 (YES at step S131), an identifier-unavailability notification signal is broadcasted under the control of the controller 2 (step S132).

According to the fifteenth embodiment, the communication apparatus 1015 automatically determines whether there is duplication of the same first identifier. Upon determining that a first identifier notified by another apparatus is already used, the communication apparatus 1015 broadcasts a signal for notifying this matter. Accordingly, a user is not required to check whether there is duplication of the same first identifier.

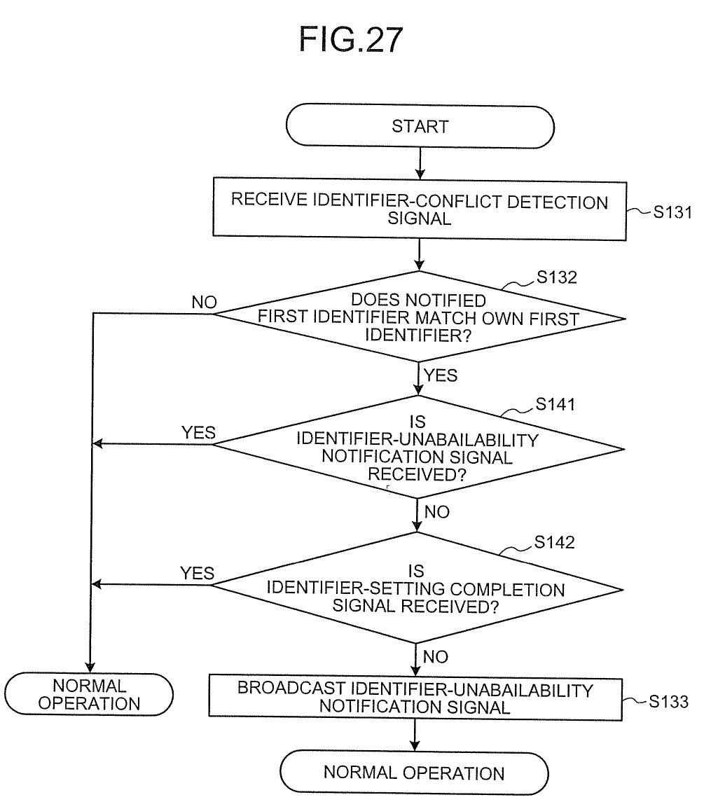

FIG. 27 is a flowchart of the operation of a communication apparatus according to a sixteenth embodiment of the present invention. The communication apparatus according to the sixteenth embodiment is of the same configuration and operates basically in a similar manner as the communication apparatus 1015 shown in FIG. 25. Therefore, the same explanations are not repeated.

Even when a first identifier notified by an identifier-conflict detection signal matches its own first identifier (YES at step S131), the communication apparatus according to the sixteenth embodiment does not broadcast an identifier-unavailability notification signal if receiving an identifier-unavailability notification signal corresponding to the identifier-conflict detection signal transmitted by another apparatus (YES at step S141), or if receiving an identifier-setting completion signal (YES at step S142).

According to the sixteenth embodiment, when receiving an identifier-unavailability notification signal transmitted by another apparatus, the communication apparatus does not broadcast an identifier-unavailability notification signal. Accordingly, an identifier-unavailability notification signal can be prevented from redundantly transmitted, which prevents an increase in useless communication load.

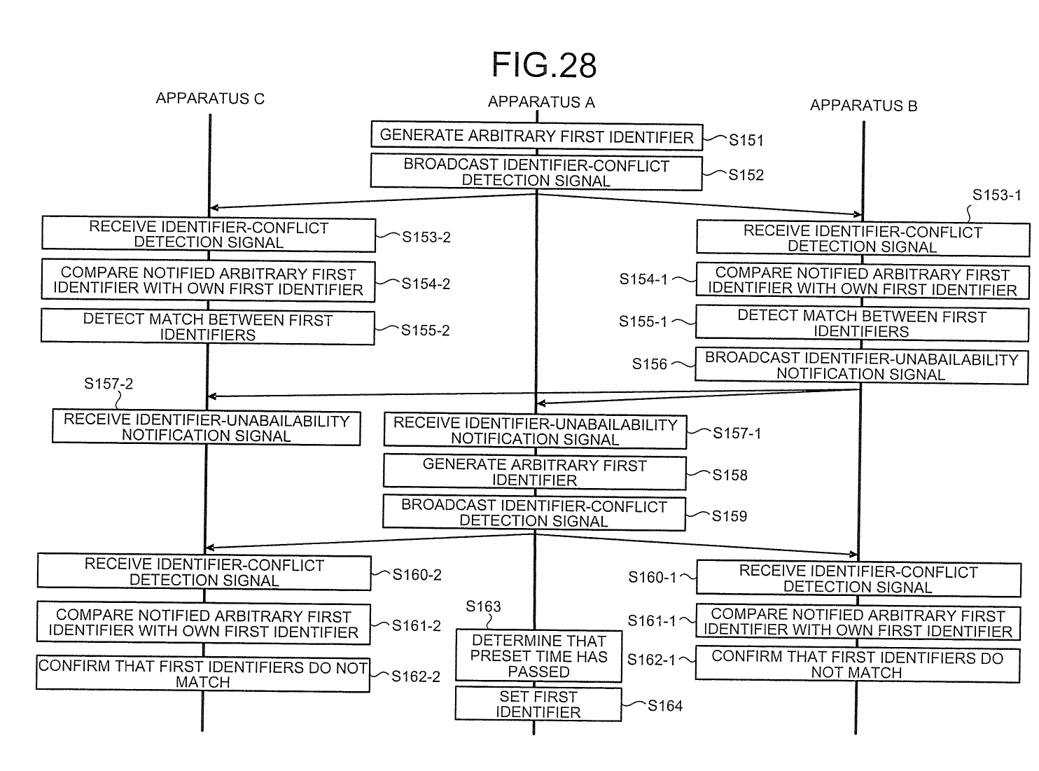

FIG. 28 is a sequence chart of the operation of a communication system according to a seventeenth embodiment of the present invention. In FIG. 28, an apparatus A is the communication apparatus according to any one of the twelfth to fourteenth embodiments, and an apparatus B and an apparatus C are the communication apparatus according to the fifteenth or sixteenth embodiment.

In FIG. 28, in the apparatus A, the first identifier generator 35 generates an arbitrary first identifier (step S151). The apparatus A notifies the apparatuses B and C of the generated arbitrary first identifier by an identifier-conflict detection signal (step S152).

In the apparatus B, upon receipt of the identifier-conflict detection signal from the apparatus A (step S153-1), the address comparator 38 compares the notified arbitrary first identifier with the first identifier of the apparatus B (step S154-1). When the notified arbitrary first identifier matches the first identifier of the apparatus B (step S155-1), the apparatus B broadcasts an identifier-unavailability notification signal (step S156).

In the apparatus C, it is detected as in the apparatus B that the arbitrary first identifier notified by the apparatus A matches its own first identifier (step S153-2, S154-2, S155-2). However, having received the identifier-unavailability notification signal from the apparatus B (step S157-2), the apparatus C does not transmit an identifier-unavailability notification signal.

The apparatus A having received the identifier-unavailability notification signal from the apparatus B (step S157-1) generates a new arbitrary first identifier (step S158), and notifies the apparatuses B and C of the new arbitrary first identifier by an identifier-conflict detection signal (step S159).

The apparatuses B and C receive the identifier-conflict detection signal transmitted from the apparatus A (step S160-1, step S160-2), and compares the notified new arbitrary first identifier with their own first identifiers (step S161-1, step S161-2). The apparatuses B and C each confirm that the new arbitrary first identifier does not match its own first identifier (step S162-1, step S162-2), and do not transmit a signal corresponding to the identifier-conflict detection signal.

When an identifier-unavailability notification signal is not received within a preset time after transmission of the identifier-conflict detection signal (step S163), the apparatus A stores the arbitrary first identifier (step S164), and uses the first identifier for communication thereafter.

With this configuration, a first identifier that has not yet assigned to another apparatus can be automatically provided to a new apparatus.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

1. A communication apparatus that constitutes a communication system including a group of communication apparatuses, in which the group is identified by a first identifier, and each of the communication apparatuses is identified by a second identifier, the communication apparatus comprising:
a storage unit that is configured to store therein a first identifier of a group to which the communication apparatus belongs;
a control unit that controls, when no first identifier has been set for the communication apparatus, exchange of signals for setting a first identifier; and
a broadcasting unit that broadcasts, under control of the control unit, a first-identifier request signal to other communication apparatuses so as to be notified of a first identifier, wherein
upon receipt of a first-identifier notification signal that includes a first identifier in response to the first-identifier request signal, the control unit stores the first identifier in the storage unit for use in communication.

2. The communication apparatus according to claim 1, wherein after storing the first identifier in the storage unit, the broadcasting unit broadcasts an identifier-setting completion signal for notifying that the first identifier has been set.

3. The communication apparatus according to claim 1, further comprising a display unit that displays indication that the first identifier is in process of being set, wherein
the display unit starts displaying the indication after broadcast of the first-identifier request signal, and
the display unit terminates displaying the indication when the first identifier is stored in the storage unit.

4. The communication apparatus according to claim 1, further comprising a first-identifier generating unit that generates, under control of the control unit, a first identifier before receipt of a first-identifier notification signal, wherein
the broadcasting unit broadcasts an identifier-conflict detection signal that includes generated first identifier, the communication apparatus further comprising:
a timer that measures a time elapsed after broadcast of the identifier-conflict detection signal, wherein
when a signal notifying that the generated first identifier is already used is not received within a predetermined time after broadcast of the identifier-conflict detection signal, the control unit stores the generated first identifier in the storage unit for use in communication.

5. The communication apparatus according to claim 4, further comprising a random-number generating unit that generates a random number, wherein
the first-identifier generating unit generates the first identifier based on the random number.

6. The communication apparatus according to claim 4, further comprising an analog-to-digital converter that converts a signal voltage on a transmission path to digital information, wherein
the first-identifier generating unit generates the first identifier based on output of the analog-to-digital converter.

7. A communication apparatus that constitutes a communication system including a group of communication apparatuses, in which the group is identified by a first identifier, and each of the communication apparatuses is identified by a second identifier, the communication apparatus comprising:
a control unit that controls, upon receipt of a first-identifier request signal for requesting notification of a first identifier from a second communication apparatus for which no first identifier has been set, exchange of signals for notifying the second communication apparatus of a first identifier;
an input unit that receives a notification instruction to broadcast a first-identifier notification signal that includes a first identifier; and
a broadcasting unit that broadcasts, under control of the control unit, a first-identifier notification signal according to the notification instruction in response to the first-identifier request signal.

8. The communication apparatus according to claim 7, further comprising a timer that measures a time elapsed after receipt of the first-identifier request signal, wherein
the broadcasting unit broadcasts, under control of the control unit, the first-identifier notification signal only when the notification instruction is received within a predetermined time after receipt of the first-identifier request signal, and ignores the notification instruction received after the predetermined time has elapsed.

9. The communication apparatus according to claim 7, wherein, upon receipt of, from the second communication apparatus, an identifier-setting completion signal for notifying that a first identifier has been set, the broadcasting unit ignores the notification instruction under control of the control unit, and does not broadcast the first-identifier notification signal.

10. The communication apparatus according to claim 7, wherein, upon receipt of a first-identifier notification signal broadcasted by a third communication apparatus in response to the first-identifier request signal from the second communication apparatus, the broadcasting unit ignores the notification instruction under control of the control unit, and does not broadcast the first-identifier notification signal.

11. The communication apparatus according to claim 7, further comprising a display unit that displays indication that the first-identifier notification signal has been broadcasted, wherein
the display unit starts displaying the indication after broadcast of the first-identifier notification signal, and
the display unit terminates displaying the indication upon receipt of an identifier-setting completion signal for notifying that a first identifier has been set corresponding to the first-identifier notification signal.

12. The communication apparatus according to claim 7, further comprising a comparing unit that compares, upon receipt of an identifier-conflict detection signal that includes a first identifier generated by the second communication apparatus from the second communication apparatus, generated first identifier with the first identifier of the communication apparatus, wherein
when the first identifiers match, the broadcasting unit broadcasts, under control of the control unit, an identifier-unavailability notification signal for notifying that the generated first identifier is already used.

13. The communication apparatus according to claim 12, wherein, upon receipt of at least one of an identifier-unavailability notification signal broadcasted by a third communication apparatus in response to the identifier-conflict detection signal, and an identifier-setting completion signal for notifying that a first identifier has been set from the second communication apparatus, the broadcasting unit does not broadcast, under control of the control unit, the identifier-unavailability notification signal.

14. A communication system that includes a group of communication apparatuses, in which the group is identified by a first identifier, and each of the communication apparatuses is identified by a second identifier, the communication system comprising:
a first communication apparatus, for which no first identifier has been set, including
a storage unit that is configured to store therein a first identifier;
a first control unit that controls exchange of signals for setting a first identifier; and
a first broadcasting unit that broadcasts, under control of the first control unit, a first-identifier request signal to other communication apparatuses so as to be notified of a first identifier; and
a second communication apparatus including
a second control unit that controls, upon receipt of the first-identifier request signal from the first communication apparatus, exchange of signals for notifying the first communication apparatus of a first identifier;
an input unit that receives a notification instruction to broadcast a first-identifier notification signal that includes a first identifier; and
a second broadcasting unit that broadcasts, under control of the second control unit, a first-identifier notification signal according to the notification instruction in response to the first-identifier request signal, wherein
upon receipt of the first-identifier notification signal in response to the first-identifier request signal, the first control unit stores the first identifier in the storage unit for use in communication.

15. The communication system according to claim 14, wherein
the first communication apparatus further includes a first display unit that displays indication that the first identifier is in process of being set,
the first display unit starts displaying the indication after broadcast of the first-identifier request signal, and terminates displaying the indication when the first identifier is stored in the storage unit,
the second communication apparatus further includes a second display unit that displays indication that the first-identifier notification signal has been broadcasted, and
the second display unit starts displaying the indication after broadcast of the first-identifier notification signal, and terminates displaying the indication upon receipt of an identifier-setting completion signal for notifying that a first identifier has been set corresponding to the first-identifier notification signal.

16. The communication system according to claim 14, wherein
the first communication apparatus further includes a first-identifier generating unit that generates, under control of the first control unit, a first identifier before receipt of a first-identifier notification signal, the first broadcasting unit broadcasts an identifier-conflict detection signal that includes generated first identifier,
the first communication apparatus further includes a timer that measures a time elapsed after broadcast of the identifier-conflict detection signal,
the second communication apparatus further includes a comparing unit that compares, upon receipt of the identifier-conflict detection signal from the first communication apparatus, the generated first identifier with the first identifier of the second communication apparatus
when the first identifiers match, the second broadcasting unit broadcasts, under control of the second control unit, an identifier-unavailability notification signal for notifying that the generated first identifier is already used, and
when the identifier-unavailability notification signal is not received within a predetermined time after broadcast of the identifier-conflict detection signal, the first control unit stores the generated first identifier in the storage unit for use in communication.
